(19) United States
(12) Patent Application Publication
(10) Pub. No.: US 2026/0027647 A1
(43) Pub. Date: Jan. 29, 2026

(54) PRODUCING A HEAT SINK

(71) Applicant: Siemens Aktiengesellschaft, 80333 München (DE)

(72) Inventors: Volker Müller, Nürnberg (DE); VLADIMIR DANOV, Erlangen (DE); PHILIPP KNEISSL, Nürnberg (DE); STEPHAN NEUGEBAUER, Erlangen (DE); FLORIAN SCHWARZ, Fürth (DE)

(73) Assignee: Siemens Aktiengesellschaft, 80333 München (DE)

(21) Appl. No.: 18/996,239

(22) PCT Filed: Jul. 5, 2023
(86) PCT No.: PCT/EP2023/068516

§ 371 Date: Jan. 17, 2025

(30) Foreign Application Priority Data
Jul. 29, 2022 (EP) 22187679.0

(51) Int. Cl. B23K 20/12; B23K 101/14; B23K 103/00; F28F 3/08; F28F 21/06

(52) U.S. Cl. CPC B23K 20/129; F28F 3/08; F28F 21/06; B23K 2101/14; B23K 2103/42; F28F 2255/16

(57) ABSTRACT

In a method for producing a heat sink, a main body is produced from a thermoplastic resin with a main cooling channel which extends from a first outer surface of the main body to a second outer surface, lying opposite the first outer surface, of the main body. An auxiliary cooling channel is produced in the main body by friction stir channeling such as to connect to the main cooling channel. The main cooling channel is closed on at least one of the first and second outer surfaces of the main body.

The invention relates to a method for producing a heat sink.

Heat sinks are used to cool electronic assemblies, among other things. In the case of such assemblies, heat is generated during operation, which must be dissipated in order to prevent the respective assembly from overheating. Such heat sinks often have an internal channel structure with cooling channels through which a cooling fluid flows in order to dissipate heat. The production of such a heat sink is cost-intensive and usually requires a plurality of different production steps.

For example, to produce a heat sink, the channel structure is first milled into a main body of the heat sink and then the main body is closed with a cover, which is then connected to the main body in a sealed and mechanically stable manner by means of vacuum brazing. Alternatively, for example, the channel structure is first milled and then cooling pipes are inserted into the channel structure.

In another method for producing a heat sink, for example, a main body with cooling channels parallel to one another is first produced by means of an extrusion method. These parallel cooling channels are then connected by means of holes running transversely thereto. The holes are often produced using complex technologies for exact drilling of the holes with a very large ratio of hole length to hole diameter. Subsequently, the parallel cooling channels and the holes are closed to the outside by means of plugs. The plugs are screwed in, for example, and the threads are additionally sealed with threadlocker.

DE 10 2020 005 113 A1 discloses a component arrangement for a motor vehicle, which has a first component and a second component, which are designed and connected to each other in a firmly bonded manner by means of a material closure facility in such a way that a space through which a fluid can flow is formed between the components, which space is fluidically sealed off from an environment of the component arrangement by the components and by the material closure facility. The material closure facility comprises a first material closure element which is produced by means of a first connection method, and a second material closure element which is produced by means of a second connection method different from the first connection method.

Kush P. Mehta et al: “A review on friction stir-based channeling”, Critical Reviews in Solid State and Materials Sciences, Vol. 47, No. 1, pages 1-45, DOI: 10.1080/10408436.2021.1886042 is a review article about so-called friction stir channeling.

WO 2017/220863 A1 discloses a rotatable and freely movable tool for producing a channel and a welded joint in a single operation. The tool comprises a shoulder and a probe, the shoulder having a surface facing the material or materials of components to be processed. The shoulder and the probe are arranged in such a way that they act in a simultaneous and synchronized manner on the materials of at least two components to be processed.

JP H11 47961 A discloses a tool in which a probe with a circumferential screw thread protruding from the tip of a rotor is provided. The tool is moved on a metallic plate, a cavity being formed in the plate.

EP 3 723 463 A1 discloses a heat exchanger, comprising a base plate with a first side and a second side opposite the first side. The first side is designed for coupling with a thermosiphon, and the base plate comprises a two-phase heat distribution structure.

CN 107 452 699 A discloses a liquid cooling plate for IGBT modules and a production method for this. The liquid cooling plate comprises a substrate in which a plurality of liquid flow grooves parallel to one another are formed through which a cooling fluid for cooling IGBT modules can flow.

The object of the invention is to specify an improved, in particular simplified, method for producing a heat sink with a cooling channel structure.

The object is achieved according to the invention by a method with the features of claim 1, a heat sink with the features of claim 9 and an electronic assembly with the features of claim 10.

The subclaims relate to advantageous embodiments of the invention.

In the method according to the invention for producing a heat sink, a main body is first of all produced with at least one main cooling channel, which extends from a first outer surface of the main body to a second outer surface, lying opposite the first outer surface, of the main body. In particular, a main body can be produced with a plurality of main cooling channels parallel to one another, each of which extends from the first outer surface to the second outer surface of the main body. At least one auxiliary cooling channel, which is connected to at least one main cooling channel, is then created in the main body by means of friction stir channeling, and at least one main cooling channel is closed on at least one outer surface of the main body.

The method according to the invention thus provides for the cooling channel structure of a heat sink to be produced in part by means of so-called friction stir channeling. This is understood to be a modification of the better known so-called friction stir welding. In friction stir welding, a gap is welded or closed by pressing a rotating tool into the gap. As a result of the rotation, the material heats up in the vicinity of the tool and softens without melting. The tool is then moved along the gap, closing the gap with the softened material. In friction stir channeling, the rotating tool is designed and moved in such a way that a channel or cavity is created in a workpiece. In friction stir channeling, a channel or a cavity created in the workpiece can also be closed immediately if necessary, so that a channel is created inside the workpiece that is closed to the outside. Friction stir channeling thus enables the simple and cost-effective creation of cooling channels in a heat sink, which in particular does not require any cost-intensive machining or vacuum brazing processes.

In an embodiment of the method according to the invention, at least one main cooling channel is closed on at least one outer surface of the main body by means of friction stir welding. For this purpose, at least one further closure part can be used if necessary, which is connected to the main body by means of friction stir welding. This embodiment of the invention thus uses friction stir welding to close main cooling channels and thus advantageously combines friction stir channeling and friction stir welding in the production of the cooling channel structure.

In a further embodiment of the method according to the invention, the main body is produced by means of extrusion. This further reduces the cost of producing the heat sink by producing the main body with main cooling channels particularly cost-effectively using extrusion.

The main body is made of a thermoplastic resin, for example of acrylonitrile butadiene styrene (ABS), a polyamide (PA), polylactate (PLA), polymethyl methacrylate (PMMA), polycarbonate (PC), polyethylene terephthalate (PET), polyethylene (PE), polypropylene (PP), polystyrene (PS), polyether ether ketone (PEEK) or polyvinyl chloride (PVC).

The aforementioned materials are particularly suitable for friction stir channeling and therefore for the production of a heat sink according to the method according to the invention.

In a further embodiment of the method according to the invention, at least two main cooling channels have different cross-sections from one another and/or at least two auxiliary cooling channels have different cross-sections from one another. By selecting suitable, coordinated cross-sections of the cooling channels, the cooling effect of the channel structure can be advantageously optimized.

In a further embodiment of the method according to the invention, at least part of the main cooling channels and auxiliary cooling channels forms channels of a pulsating heat pipe. A pulsating heat pipe (PHP for short), which is also referred to as an oscillating heat pipe, has a thin channel, usually with many bends, which is partially filled with a liquid. As the liquid does not completely fill the volume of the channel, liquid areas filled with the liquid are formed in the channel by the surface tension of the liquid on the wall of the channel, which are separated from one another by vapor areas formed by vapor. As a result of temperature differences in different sections of the heat pipe, the liquid areas pulsate or oscillate and enable heat transport and temperature compensation between these sections. The method according to the invention is also particularly suitable for the production of a heat sink with a pulsating heat pipe.

A heat sink according to the invention is produced with the method according to the invention.

An electronic assembly according to the invention has a heat sink according to the invention.

The properties, features and advantages of the present invention described above and the manner in which they are achieved will become clearer and more comprehensible in connection with the following description of exemplary embodiments, which are explained in more detail with reference to the drawings, in which:

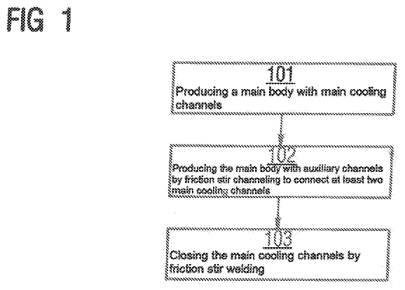

FIG. 1 shows a flow chart of an exemplary embodiment of the method according to the invention, heat sink,

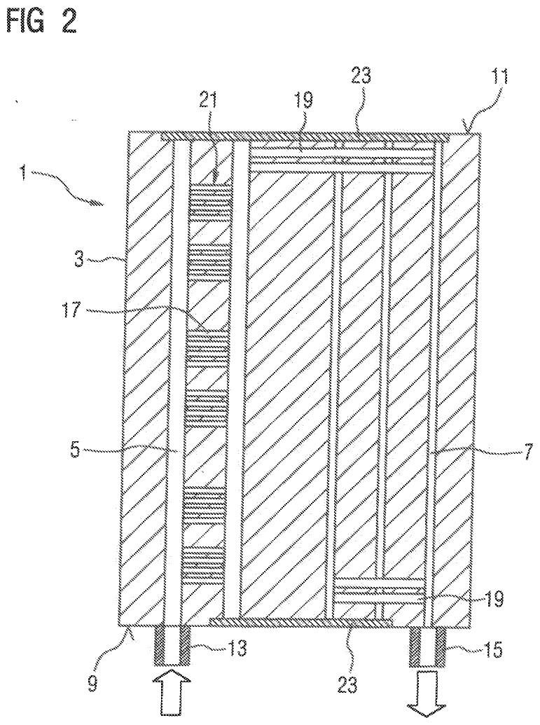

FIG. 2 shows a sectional view of an exemplary embodiment of a

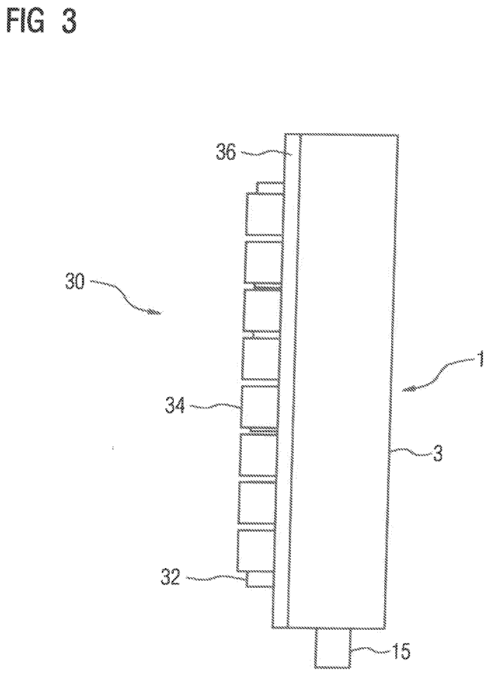

FIG. 3 shows a lateral view of an exemplary embodiment of an electronic assembly,

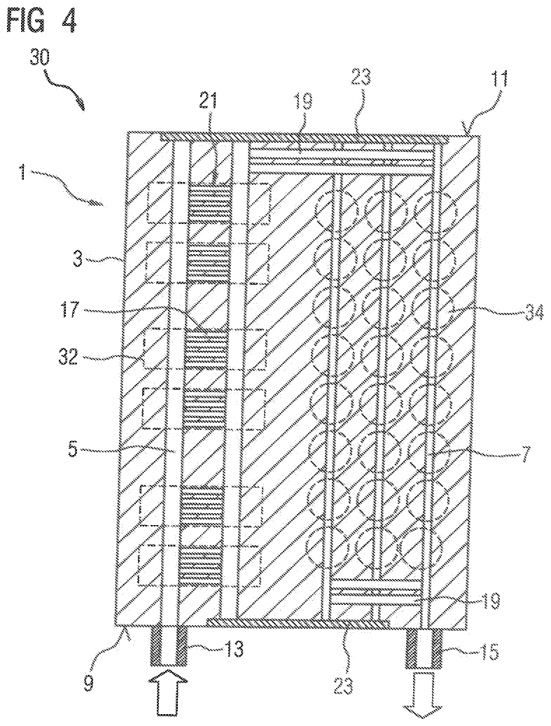

FIG. 4 shows a sectional view of the electronic assembly shown in FIG. 3.

Corresponding parts are marked with the same reference characters in the figures.

FIG. 1 shows a flow chart of an exemplary embodiment of the method according to the invention with method steps 101, 102, 103 for producing a heat sink 1.

The method steps 101, 102, 103 are also described hereinafter with reference to FIG. 2.

FIG. 2 shows an exemplary embodiment of a heat sink 1 produced using the method according to the invention.

In a first method step 101, a main body 3 is produced with main cooling channels 5, 7 parallel to one other, which in each case extend from a first outer surface 9 of the main body 3 to a second outer surface 11, lying opposite the first outer surface 9, of the main body 3. In the exemplary embodiment shown in FIG. 2, the main body 3 has five main cooling channels 5, 7 of which two first main cooling channels 5 have the same cross-sections and three second main cooling channels 7 also have the same cross-sections, but these are smaller than the cross-sections of the first main cooling channels 5. A first main cooling channel 5 is connected to an inlet 13 of the heat sink 1 for introducing a cooling fluid. A second main cooling channel 7 is connected to an outlet 15 of the heat sink 1 for discharging the cooling fluid.

The main body 3 is produced, for example, by means of extrusion.

The main body 3 is made of a thermoplastic resin, for example of acrylonitrile butadiene styrene, a polyamide, polylactate, polymethyl methacrylate, polycarbonate, polyethylene terephthalate, polyethylene, polypropylene, polystyrene, polyether ether ketone or polyvinyl chloride.

In a second method step 102, auxiliary cooling channels 17, 19, each of which connects at least two main cooling channels 5, 7, are produced by means of friction stir channeling. In the exemplary embodiment shown in FIG. 2, the auxiliary cooling channels 17, 19 run perpendicular to the main cooling channels 5, 7. In this case, similar first auxiliary cooling channels 17 each connect the two first main cooling channels 5 to one another. The first auxiliary cooling channels 17 form a plurality of auxiliary cooling channel groups 21 spaced apart from one another, each of which has a plurality of first auxiliary cooling channels 17. Second auxiliary cooling channels 19 each connect a first main cooling channel 5 to at least one second main cooling channel 7 or at least two second main cooling channels 7. The first auxiliary cooling channels 17 have smaller cross-sections than the second auxiliary cooling channels 19. Preferably, the auxiliary cooling channels 17, 19 produced by means of friction stir channeling are also closed by means of friction stir channeling, so that no openings are created on an external side of the main body 3 as a result of the friction stir channeling.

In a third method step 103, the main cooling channels 5, 7 are closed on the outer surfaces 9, 11, with the exception of the inlet 13 and the outlet 15. For example, the main cooling channels 5, 7 are closed by means of friction stir welding. The resulting weld seams 23 are shown in FIG. 2. If, in the second method step 102, openings on an external side of the main body 3 have been created by the friction stir channeling which have not already been closed by the friction stir channeling, these openings are also closed in the third method step 103, for example also by friction stir welding.

FIG. 3 and FIG. 4 show an exemplary embodiment of an electronic assembly 30 with a heat sink 1 which is embodied and produced like the heat sink 1 shown in FIG. 2. FIG. 3 shows a lateral view of the electronic assembly 30. The electronic assembly 30 has a plurality of electronic components 32, 34. For example, first electronic components 32 are semiconductor switches like IGBTs (IGBT: abbreviation for Insulated-Gate Bipolar Transistor) and second electronic components 34 are capacitors. The electronic components 32, 34 are arranged on a base plate 36 which abuts the heat sink 1. FIG. 4 shows a sectional view of the electronic assembly 30, the sectional plane extending through the heat sink 1 as in FIG. 2. FIG. 4 indicates with dashed lines the position of the electronic components 32, 34 relative to the main cooling channels 5, 7 and auxiliary cooling channels 17, 19. The auxiliary cooling channel groups 21 are arranged in areas which each correspond to the position of a first electronic component 32. The second main cooling channels 7 extend in areas which correspond to the position of the second electronic components 34.

Although the invention has been illustrated and described in more detail by preferred exemplary embodiments, the invention is not limited by the disclosed examples and other variations may be derived therefrom by a person skilled in the art without departing from the scope of the invention.

1.-9. (canceled)

10. A method for producing a heat sink, the method comprising:
producing a main body from a thermoplastic resin with a main cooling channel which extends from a first outer surface of the main body to a second outer surface, lying opposite the first outer surface, of the main body;
producing an auxiliary cooling channel in the main body by friction stir channeling such as to connect to the main cooling channel; and
closing the main cooling channel on at least one of the first and second outer surfaces of the main body.

11. The method of claim 10, further comprising producing the main body with a plurality of said main cooling channel in parallel relation to one another and extending from the first outer surface to the second outer surface of the main body.

12. The method of claim 10, wherein the main cooling channel is closed on at least one of the first and second outer surfaces of the main body by friction stir welding.

13. The method of claim 10, wherein the main body is produced by extrusion.

14. The method of claim 10, wherein the main body is made of acrylonitrile butadiene styrene, a polyamide, polylactate, polymethyl methacrylate, polycarbonate, polyethylene terephthalate, polyethylene, polypropylene, polystyrene, polyether ether ketone or polyvinyl chloride.

15. The method of claim 11, wherein at least two of the main cooling channels have different cross-sections from one another.

16. The method of claim 11, further comprising producing the main body with a plurality of said auxiliary cooling channel such that at least two of the auxiliary cooling channels have different cross-sections from one another.

17. The method of claim 16, wherein at least part of the main cooling channels and the auxiliary cooling channels forms channels of a pulsating heat pipe.

18. A heat sink, comprising:
a main body made from a thermoplastic resin and including a first outer surface and a second outer surface lying opposite the first outer surface;
a main cooling channel formed in the main body and extending from the first outer surface of the main body to the second outer surface of the main body, said main cooling channel being closed on at least one of the first and second outer surfaces of the main body; and
an auxiliary cooling channel formed in the main body by friction stir channeling such as to connect to the main cooling channel.

19. The heat sink of claim 18, further comprising a plurality of said main cooling channel in parallel relation to one another and extending from the first outer surface to the second outer surface of the main body.

20. The heat sink of claim 18, wherein the main cooling channel is closed on at least one of the first and second outer surfaces of the main body by friction stir welding.

21. The heat sink of claim 18, wherein the main body is produced by extrusion.

22. The heat sink of claim 18, wherein the main body is made of acrylonitrile butadiene styrene, a polyamide, polylactate, polymethyl methacrylate, polycarbonate, polyethylene terephthalate, polyethylene, polypropylene, polystyrene, polyether ether ketone or polyvinyl chloride.

23. The heat sink of claim 19, wherein at least two of the main cooling channels have different cross-sections from one another.

24. The heat sink of claim 19, further comprising a plurality of said auxiliary cooling channel, with at least two of the auxiliary cooling channels having different cross-sections from one another.

25. The heat sink of claim 24, wherein at least part of the main cooling channels and the auxiliary cooling channels forms channels of a pulsating heat pipe.

26. An electronic assembly, comprising the heat sink of claim 18.
